(19) United States
(12) Patent Application Publication
(10) Pub. No.: US 2021/0178570 A1
(43) Pub. Date: Jun. 17, 2021

(54) Accessories for Electric Angle Grinder Stand

(71) Applicant: Dillon Christopher King, Oklahoma City, OK (US)

(72) Inventor: Dillon Christopher King, Oklahoma City, OK (US)

(21) Appl. No.: 16/714,749

(22) Filed: Dec. 15, 2019

(51) Int. Cl. B25H 3/00; B25H 3/04

(52) U.S. Cl. CPC B25H 3/006; B25H 3/04

(57) ABSTRACT

An improved angle grinder holder and an accessory organizer for an angle grinder holder, wherein the angle grinder holder comprises a tilted plate having one or more notches formed in a top edge of the tilted plate for receiving one or more angle grinders, and a stand to support the tilted plate on a surface or mount the tilted plate to another structure, the accessory organizer comprising one or more accessory holders affixed to the tilted plate or to the holder support structure which are configured to receive one or more angle grinding accessories which are not angle grinders per se.

### FIELD OF THE INVENTION

The invention generally relates to efficient systems for electric tool holders and stands, and in particular for stands for electric angle grinders.

### BACKGROUND OF THE INVENTION

Angle grinders, sometimes also referred to as disc grinders and side grinders, are handheld electric power tools which are used in a variety of fabrication, construction and repair processes, such as grinding away coatings and corrosion, finishing welds, and shaping repairs to vehicle bodies, to name a few. Angle grinders can even be used in emergency operations to cut away metal bars and struts that may be causing entrapment of a victim. The discs used with angle grinders can range from highly abrasive for cutting discs for cutting metals, fiberglass, and concrete, to moderately abrasive for carefully removing excess material from welds, joints and glues, to mildly abrasive for polishing surfaces to a smooth finish ready for painting, coating, or plating.

Skilled users of angle grinders typically have two or more grinders that they use during their operations and tasks, whereas different angle grinders may be more suitable or provide better handling for certain tasks more than for other tasks, and where the user may need two or three different disc types so he or she will load one angle grinder with each of the different disc types needed.

Most angle grinders are powered by electrical mains current, such as 120 VAC in the USA or 240 VAC in much of the rest of the world. Some angle grinders are powered by rechargeable batteries, which allows for use in remote locations where electrical mains current is not available or suitable, such as wet working environments.

### SUMMARY OF THE DISCLOSED EMBODIMENT(S)

Disclosed are an improved angle grinder holder and an accessory organizer for an angle grinder holder, wherein the angle grinder holder comprises a tilted plate having one or more notches formed in a top edge of the tilted plate for receiving one or more angle grinders, and a holder support structure to stand the tilted plate on a surface or mount the tilted plate to another structure, the accessory organizer comprising one or more accessory holders affixed to the tilted plate, or to the holder support structure which are configured to receive one or more angle grinding accessories which are not angle grinders per se.

### BRIEF DESCRIPTION OF THE DRAWINGS

The description of exemplary embodiments of the invention as set forth herein are illustrated by the several drawings.

FIG. 1 illustrates an improved angle grinder holder according to at least one embodiment of the present invention.

FIG. 2 illustrates an accessory organizer for an angle grinder holder according to at least one embodiment of the present invention.

FIG. 3 illustrates use of the accessory organizer of FIG. 2 with a conventional angle grinder holder to realize an improved angle grinder holder.

FIG. 4 illustrates another embodiment of an accessory organizer according to at least one embodiment of the present invention.

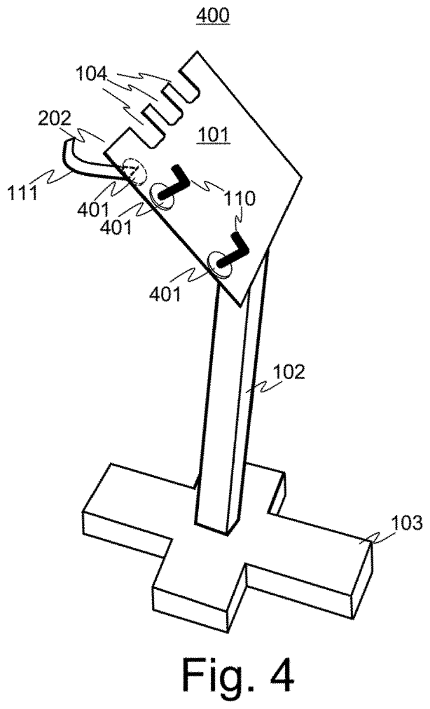

FIG. 5 illustrates at least one method of manufacturing an improved angle grinder holder according to the present invention utilizing pre-cut, pre-formed accessory organizers.

FIG. 6 depicts an actual prototype of at least one embodiment according to the present invention.

### DETAILED DESCRIPTION OF ONE OR MORE EXEMPLARY EMBODIMENT(S) OF THE INVENTION

The inventor of the present invention has recognized a problem in the art not previously recognized or addressed by designers and manufacturers of accessories and tools often used with angle grinders. Electric angle grinders, and especially corded angle grinders, are of an odd shape such that they do not lay flat on a work bench well without sliding, falling or pivoting around on the work bench top. Laying angle grinders on the floor of a workshop requires the user to make multiple bends and crouches to lay them down and pick them up, and in some environments such as working outdoors or in a wet area, putting them on the ground or floor is not an option.

There are at least two angle grinder holders known to be available on the market today which provide a solution as to where to securely place one or more angle grinders when not in use, but also to provide for easy access to the user with minimal repetitive motions to retrieve and replace the angle grinder from the holder. Both units known to be on the market are similar, and are generally shaped similar to a music stand with one or more notches along a top edge of a tilted plate to receive the drive shaft of an angle grinder. The angle grinder is captured by gravity pull into the notch, with the disc and disc guard on the underside of the tilted plate of the holder and the handle and motor portion of the angle grinder supported and resting on the top side of the tilted plate. Two examples of such angle grinder holders are the Javelin model available from Castle Weld Shop [TM] of Edson, Alberta, Canada, and the Model 412 grinder holder available from Sawyer Manufacturing Co. of Tulsa, Okla., USA. Both offer two or more notches to hold two or more grinders, with a variety of options for free-standing use or bench-mounted use.

However, the present inventor has recognized that angle grinding operations often involve a number of other tools, including non-power hand tools such as pliers, additional discs to replace discs as they are ground away (used up) and for varying abrasion levels, and one or more face masks to protect the user from flying metal shavings and ground-away dusk and particles. Even with the angle grinder holders available on the market, a user has a large number of accessory tools and parts which are loose and cumbersome to manage.

The present invention provides a variety of accessories to transform a plain angle grinder holder into an angle grinding organizer, which when coupled with or to an angle grinder holder, allows a user to securely arrange, organize, access and store the variety of necessary discs, masks and hand tools that are most often associated with angle grinding tasks and operations.

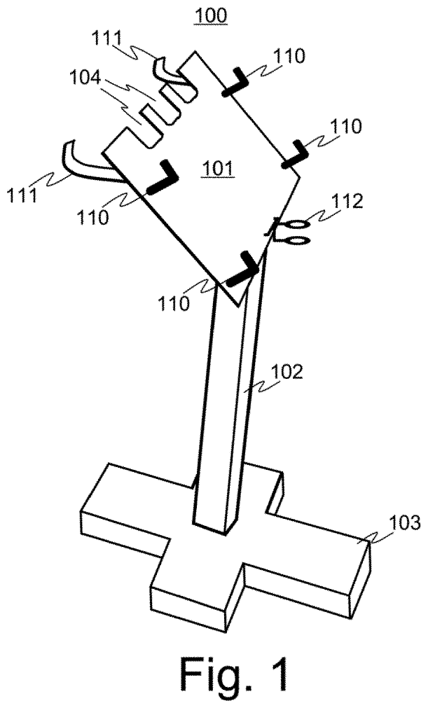

Turning to FIG. 1, one available embodiment (100) of such an improved angle grinder holder according to the present invention is shown. The base angle grinder holder includes a tilted plate (101) with one or more notches (104) formed across a top edge to receive the power output shaft(s) of one or more angle grinders in the convention manner, such that the disc and disc guards are received below the tilted plate (101), and the handle and motor portion of the angle grinders are received above the tilted plate (101) so that gravity retains the angle grinders resting on the top surface of the tilted plate, securely captured by the power output shafts in the notches. The base angle grinder holder also includes some sort of stand or mounting option, such as a floor stand (102) and base (103) or an optional bench mount (not shown). With such a conventional angle grinder holder, a user can easily lift a grinder from the tool, and replace a grinder on the holder with minimal effort and attention, thereby reducing time and effort spent on repetitive motions and improving productivity while reducing repetitive motion injury.

It should be noted that in some embodiments, rather than the three notches (104) as shown in FIG. 1, the center notch may be replaced with a cut out for a handle. In yet other embodiments, there may be only one notch, or may be more than 3 notches. In still other embodiments, holes may be formed along the top edge of the tilted plate for attachment of a handle.

The improvements in this exemplary embodiment according to the invention comprise one or more additional accessories such as a plurality of disc holding studs (110) for receiving one or more discs (e.g., stacks of discs), one or more face mask or helmet hooks (111), and one or more ring holders (112) for hand tools, such as pliers. This exemplary embodiment arranges the face masks on hooks (111) on the bottom surface of the tilted plate (101), and allows for stacks of discs to be received, organized and securely held by gravity on the studs (110) protruding from the top surface of the tilted plate (101). In other embodiments, the face mask hooks may be attached to the base holder in other manners and in other places along the edges, stand, mount, or surfaces of the base holder. In other embodiments, more or fewer of the holder accessories (110, 111, 112)

In the embodiment of FIG. 1, the one or more holder accessories (110, 111, 112) may be attached to the base holder (101, 102, 103) via permanent means, such as welding, epoxy, etc., or by removable means, such as by threaded bolts and nuts, rivets, hooks, bendable tabs, twistable tabs, slots, etc. In at least one embodiment, holes may be formed into the tilted plate of common sizes and spacing to replicate common peg board hole pattern so that the one or more holder accessories (110, 111, 112) may be interchangeably used between the improved angle grinder holder and a wall-mounted peg board.

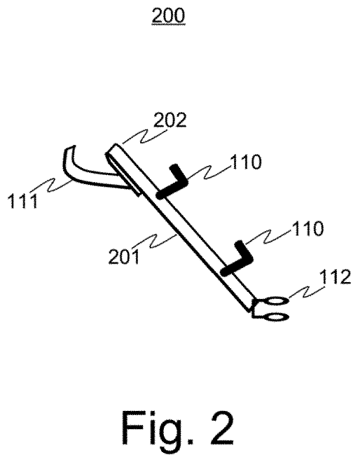

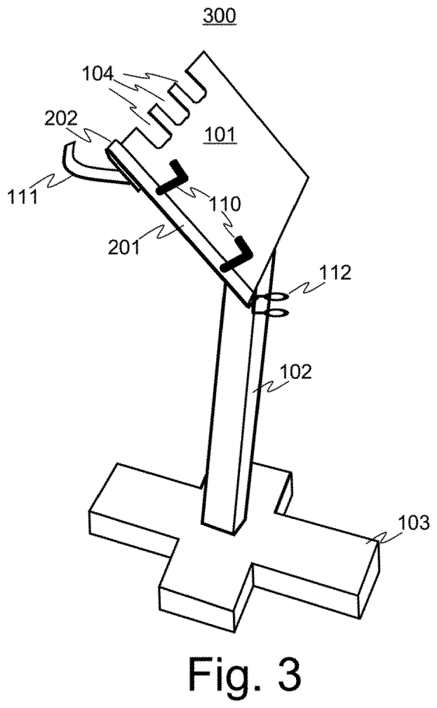

Turning to FIG. 2, another available embodiment according to the present invention carries the one or more holder accessories (110, 111, 112) on a J-shaped carrier strip (201), which provides a hook portion (202) which can be received over a top edge of a tilted plate (101) of a base holder, as shown in FIG. 3. This embodiment allows for after-market attachment of the one or more holder accessories (110, 111, 112) to a base holder, and it can be optionally secured using a thumbscrew, magnet, bolt, tab, or other means to the tilted plate. It may also allow a user to quickly remove the one or more holder accessories (110, 111, 112) to provide full use of the top surface of the base holder when needed, and to quickly replace the one or more holder accessories (110, 111, 112) when the user needs quicker access to all the related tools and parts organized by the one or more holder accessories (110, 111, 112).

Referring now to FIG. 3, another available embodiment allows for attachment of the one or more holder accessories (110, 111, 112) to a base holder via powerful base magnets (401), such as round base magnets available from Master Magnetics, Inc., of Castle Rock, Colo., USA. This not only allows for easy, tool-free installation and removal, but also allows the user to reposition and re-arrange the one or more holder accessories (110, 111, 112) to achieve the spacing and configuration that best suits his or her particular needs.

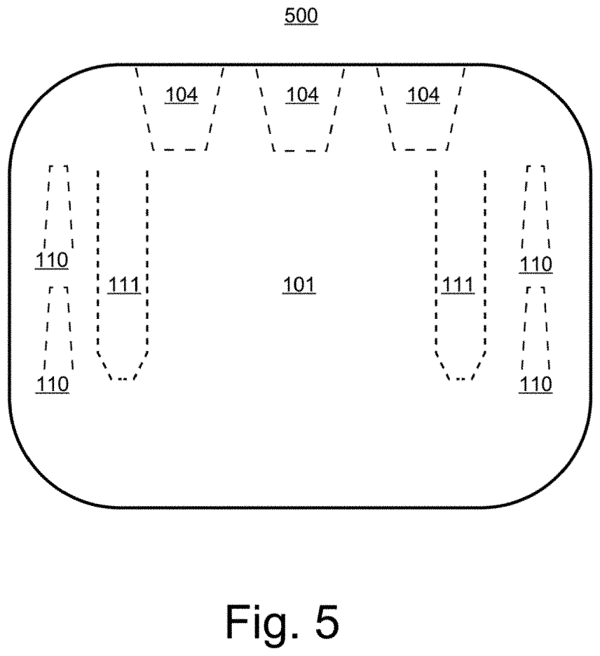

FIG. 5 illustrates another embodiment (500) according to the invention, in which a plate of material, such as metal, is shaped to form the tilted plate (101) with notches (104) for the angle grinder holder cut away (dotted lines). And, additionally the one or more holder accessories (110, 111, 112) are pre-formed into the plate (101) by cutting or routing U-shaped cuts into the flat plate material. Then, upon final assembly, the disk holder studs (110) are fully formed by bending the U-shaped portion towards the front (top) of the plate (101), and the mask hooks (111) are fully formed by bending the U-shaped portions towards the back (bottom) of the plate (101). Depending on the thickness and strength of the plate material, this operation may be performed during manufacturing of the improved angle grinder holder, or it may be packed and shipped in its flat state until it is unpacked, assembled, and fully formed (e.g., bends made) by the consumer user.

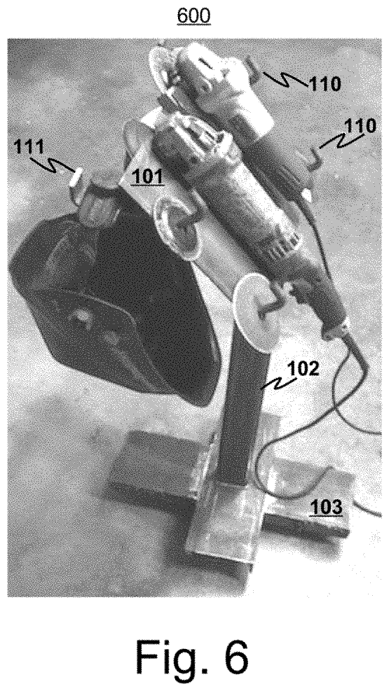

FIG. 6 shows an actual prototype of an improved angle grinder holder (600) fully loaded with two angle grinders, four disc studs (110) holding spare or extra discs, and two mask hooks (111) holding one face mask to illustrate at least one method of use of at least one embodiment of the present invention.

### CONCLUSION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless specifically stated otherwise.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

It will be readily recognized by those skilled in the art that the foregoing example embodiments do not define the extent or scope of the present invention, but instead are provided as illustrations of how to make and use at least one embodiment of the invention. The following claims define the extent and scope of at least one invention disclosed herein.

I claim:

1. An improved angle grinder holder comprising:
a tilted plate having one or more notches formed in a top edge of the tilted plate for receiving one or more angle grinders;
a stand affixed to the tilted plate to support the tilted plate on a surface or mount the tilted plate to a structure;
one or more accessory holders affixed to the tilted plate or to the stand, the one or more accessory holders being configured to receive one or more angle grinding accessories which are not angle grinders per se.

2. The improved angle grinder holder as set forth in claim 1 wherein the one or more accessory holders comprise at least one stud protruding towards a top surface of the tilted plate for receiving one or more angle grinding discs.

3. The improved angle grinder holder as set forth in claim 2 wherein the at least one stud is affixed to the tilted plate via one or more attachments selected from the group consisting of a carrier strip, a bolt, a weld, glue, a magnetic base, a bent tab, a twisted tab, a pegboard hook, and a slot.

4. The improved angle grinder holder as set forth in claim 1 wherein the one or more accessory holders comprise at least one hook protruding towards a bottom surface of the tilted plate for receiving one or more face masks.

5. The improved angle grinder holder as set forth in claim 4 wherein the at least one hook is affixed to the tilted plate via one or more attachments selected from the group consisting of a carrier strip, a bolt, a weld, glue, a magnetic base, a bent tab, a twisted tab, a pegboard hook, and a slot.

6. The improved angle grinder holder as set forth in claim 1 wherein the one or more accessory holders comprise at least one ring for receiving one or more hand tools which are not angle grinders per se.

7. The improved angle grinder holder as set forth in claim 6 wherein the at least one ring is affixed to the tilted plate via one or more attachments selected from the group consisting of a carrier strip, a bolt, a weld, glue, a magnetic base, a bent tab, a twisted tab, a pegboard hook, and a slot.

8. An accessory organizer for an angle grinder holder, wherein the angle grinder holder comprises a tilted plate having one or more notches formed in a top edge of the tilted plate for receiving one or more angle grinders, and a stand to support the tilted plate on a surface or mount the tilted plate to another structure, the accessory organizer comprising one or more accessory holders affixed to the tilted plate or to the holder support structure, the one or more accessory holders being configured to receive one or more angle grinding accessories which are not angle grinders per se.

9. The accessory organizer as set forth in claim 8 wherein the one or more accessory holders comprise at least one stud protruding towards a top surface of the tilted plate for receiving one or more angle grinding discs.

10. The accessory organizer as set forth in claim 9 wherein the at least one stud is affixed to the tilted plate via one or more attachments selected from the group consisting of a carrier strip, a bolt, a weld, glue, a magnetic base, a bent tab, a twisted tab, a pegboard hook, and a slot.

11. The accessory organizer as set forth in claim 8 wherein the one or more accessory holders comprise at least one hook protruding towards a bottom surface of the tilted plate for receiving one or more face masks.

12. The accessory organizer as set forth in claim 11 wherein the at least one hook is affixed to the tilted plate via one or more attachments selected from the group consisting of a carrier strip, a bolt, a weld, glue, a magnetic base, a bent tab, a twisted tab, a pegboard hook, and a slot.

13. The accessory organizer as set forth in claim 8 wherein the one or more accessory holders comprise at least one ring for receiving one or more hand tools which are not angle grinders per se.

14. The accessory organizer as set forth in claim 13 wherein the at least one ring is affixed to the tilted plate via one or more attachments selected from the group consisting of a carrier strip, a bolt, a weld, glue, a magnetic base, a bent tab, a twisted tab, a pegboard hook, and a slot.
